(19) United States
(12) Patent Application Publication
(10) Pub. No.: US 2005/0283357 A1
(43) Pub. Date: Dec. 22, 2005

(54) Text mining method

(75) Inventors: C. James MacLennan, Redmond, WA (US); Hang Li, Beijing (CN); Ming Zhou, Beijing (CN); Yunbo Cao, Beijing (CN); ZhaoHui Tang, Bellevue, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/970,586

(22) Filed: Oct. 21, 2004

Related U.S. Application Data
(60) Provisional application No. 60/581,956, filed on Jun. 22, 2004.

(51) Int. Cl. G06F 17/28

(52) U.S. Cl. 704/4

(57) ABSTRACT

A method for performing data mining is provided. The method includes selecting at least one data source of unstructured text. Additionally, a transformation is selected to identify a list of terms in the unstructured text. A run-time path is established to connect the data source to the transformation to load the list of terms identified into a destination database.

### CROSS REFERENCE TO RELATED APPLICATION

The present application is based on and claims the benefit of U.S. provisional patent application Ser. No. 60/581,956 filed Jun. 22, 2004, the content of which is hereby incorporated by reference in its entirety.

### BACKGROUND OF THE INVENTION

The present invention relates to data mining. In particular, the present invention relates to performing data transformations for data mining purposes.

Data mining relates to processing data to identify patterns within the data. These patterns within the data provide an effective analysis tool to aid in decision making. Text mining relates to the extension of data mining to articles and other text documents that generally include unstructured text. Text mining can aid in classifying documents for research, detecting situations within reports, predict effectiveness for various procedures and gauge success for different operations.

Different forms of text mining utilizing a computer include keyword searches and various relevance ranking algorithms. While these methods can be effective, a sufficient amount of individual's time can still be needed in order to effectively discover and identify relevant documents. Due to the vast amount of articles, e-mail messages, reports and other unstructured data, excessive amounts of individual classification can be time consuming and expensive. As a result, an effective way to perform data mining on unstructured data would provide an effective tool.

### SUMMARY OF THE INVENTION

A method for performing data mining is provided. The method includes selecting at least one data source of unstructured text. Additionally, a transformation is selected to identify a list of terms in the unstructured text. A run-time path is established to connect the data source to the unstructured text to load the list of terms identified into a destination database.

### BRIEF DESCRIPTION OF THE DRAWINGS

FIG. 1 illustrates a general computing environment.

FIG. 2 is a block diagram of an environment for performing extraction, transformation and loading processing tasks.

FIG. 3 is a flow diagram of a method for defining extraction, transformation and loading processing tasks.

FIG. 4 is a flow diagram of an exemplary term extraction transformation.

FIG. 5 is a flow diagram of an exemplary term look-up transformation.

FIG. 6 is an exemplary method for performing term extraction on a collection of articles.

FIG. 7 is a flow diagram of a method for performing term look-up on one or more documents.

FIGS. 8-10 illustrate an exemplary user interface for defining and implementing a text mining process.

### DETAILED DESCRIPTION OF ILLUSTRATIVE EMBODIMENTS

The present invention relates to utilizing extraction, transformation and loading processes to provide an efficient tool for text mining. Using the present invention, transformation modules can be utilized in order to establish a pipeline for text mining. In particular, a term extraction transformation and a term look-up transformation can be utilized to provide effective text mining. Before addressing the present invention in further detail, a suitable environment for use with the present invention will be described.

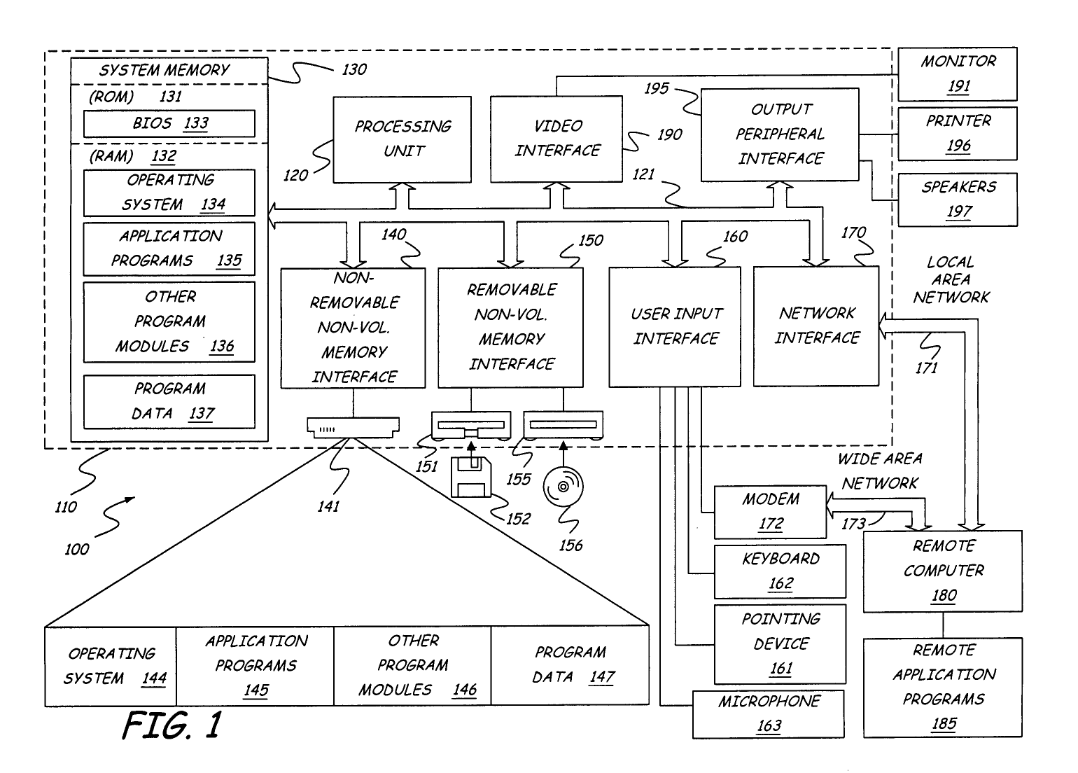

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. For natural user interface applications, a user may further communicate with the computer using speech, handwriting, gaze (eye movement), and other gestures. To facilitate a natural user interface, a computer may include microphones, writing pads, cameras, motion sensors, and other devices for capturing user gestures. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

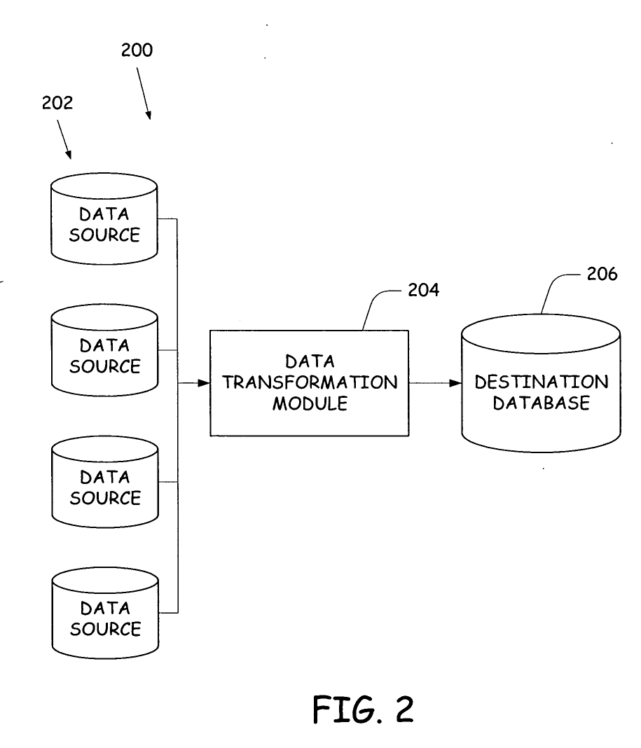

FIG. 2 is a block diagram of an environment 200 for extraction, transformation and loading of data for processing. One or more data sources 202 are provided for extraction. These data sources can be emails, voicemails, news articles, reports, etc. It is also worth noting that the data sources can be in different languages. Information is extracted from data source 202 by data transformation module 204, which then performs one or more transformations on the extracted information. For example, data transformation module 204 can provide data consolidation, archiving, filtering, merging, extraction, look-up etc. Multiple transformations can be arranged in a pipeline to provide repeatable text mining processes for training and classifying. Once the one or more transformations are performed, data transformation module 204 loads the transformed data into a destination database 206.

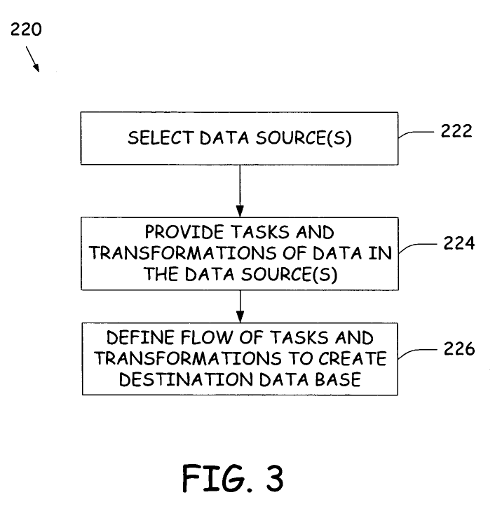

FIG. 3 is a flow diagram of a method 220 for defining extraction, transformation and loading processing tasks for text mining in environment 200 of FIG. 2. In one embodiment, a graphical user interface such as data transformation services (DTS) in Microsoft SQL server provided by Microsoft Corporation of Redmond, Wash., can be utilized to define a text mining process. In method 220, one or more data sources are selected at step 222. For example, these data sources can relate to e-mail messages, text articles, voice messages, etc. During text mining, a connection is made to the data sources selected. At step 224, tasks and transformations of data in the data sources are selected. For example, the tasks and transformation can include merging, consolidation, extraction and/or look-up that are selected from a graphical user interface.

At step 226, a flow of tasks and transformations to create a destination database is defined. This flow creates a pipeline for data that can easily be viewed and modified such that text mining can be easily performed. Method 220 can be used for different text mining tasks such as analyzing a training corpus for patterns and/or identifying relevance of new documents. As discussed below, two such transformation used for these processes are term extraction and term look-up that can form part of the pipeline for text mining processes. These transformations identify a list of terms in the one or more data sources. Data resulting from these transformations can be loaded into other databases and/or be used with other data mining processes in a run-time environment.

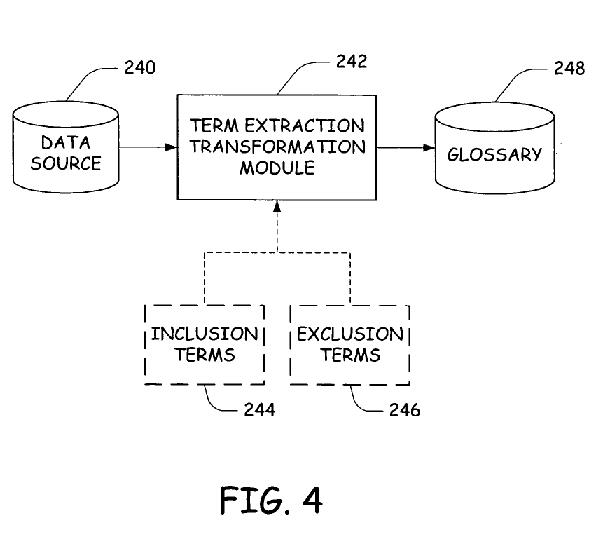

FIG. 4 is a flow diagram for performing a term extraction transformation to implement a text mining procedure. The term extraction transformation identifies noun phrases in text that are combined to form a glossary. A data source 240, which can for example be a collection of articles, is provided. Alternatively, more than one data source can be provided. A term extraction transformation module 242 identifies terms (i.e. noun phrases) in data source 240.

If desired, an inclusion terms list 244 and an exclusion terms list 246 can be utilized by term extraction transformation module 242. The inclusion terms list 244 can include words and/or phrases that are particularly relevant to the desired text mining procedure. In contrast, the exclusion terms list 246 can include words and/or phrases that are either too popular or too trivial (i.e. non discriminative) based on the desired text mining procedure.

These lists can generated using a statistical measure such as tf-idf ranking (term frequency-inverse document frequency). A tf-idf ranking measure is a way of weighting relevance of a term to a document. The tf-idf ranking takes into account term frequency (tf) in a given document and the inverse document frequency (idf) of the term in a collection of documents. Term frequency in a measure of how important a term is in the given document and the document frequency of the term (i.e. the percentage of documents that contain the term) is a measure of how important the term is for a text mining procedure.

Terms extracted from data source 240 are loaded into a glossary 248 based on the term extraction transformation module 242. If lists 244 and 246 are used, terms from the inclusion terms list 244 are loaded into the glossary 248 while terms from exclusion list 246 are excluded from glossary 248. The glossary 248 can be used during a term look-up transformation as discussed below or for other data mining purposes.

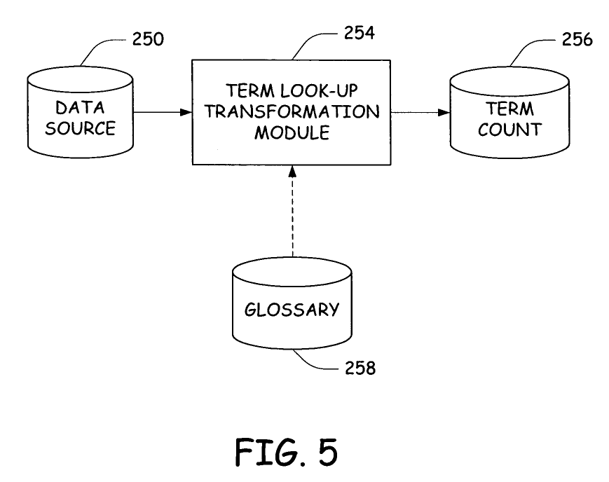

FIG. 5 is a flow diagram of an exemplary term look-up transformation. A data source 250 is identified for the transformation to implement a text mining procedure. A term look-up transformation module 254 counts terms within data source 250 to perform the look-up transformation. In one embodiment, a glossary 256 is utilized in order to look-up terms in data source 250. Glossary 256 can be developed using a term extraction transformation as discussed above. Term look-up transformation module 254 loads terms as well as a count of terms identified in data source 250 into term count database 258.

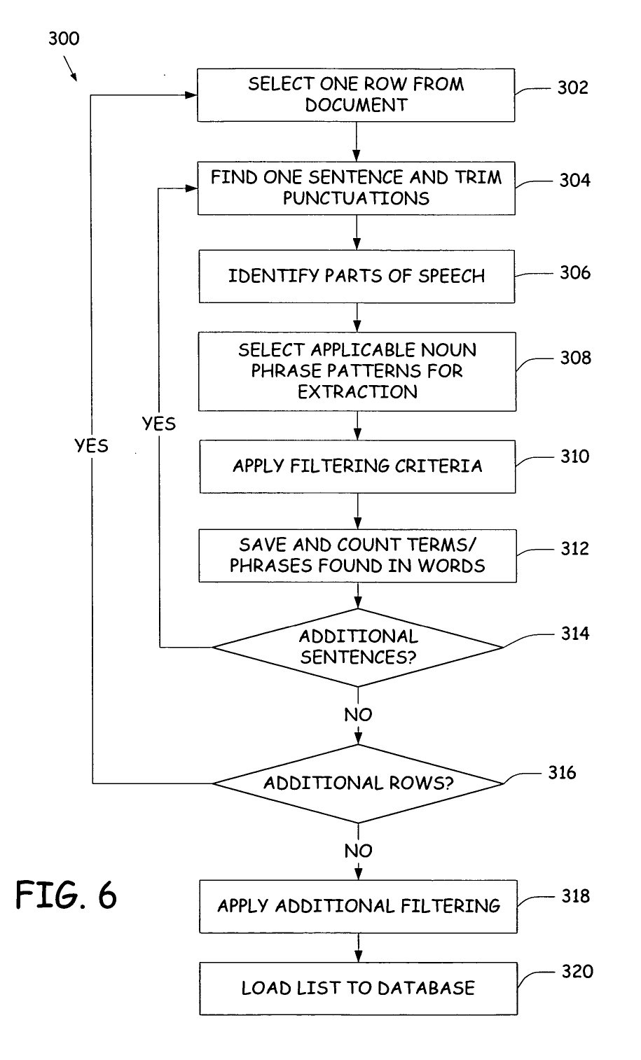

FIG. 6 is an exemplary method 300 for performing term extraction on a collection of articles. As an example, method 300 can be performed by term extraction transformation module 242. At step 302, method 300 begins by selecting a row from a document. In the case of an article, a row of text is selected. At step 304, a sentence is found and punctuations are trimmed from the sentence in order to obtain a set of words. At step 306, parts of speech can be identified in the collection of words, for example by performing a parsing process using a statistical language model. Further processing of the terms/phrases can be performed during parsing, such as stemming and case conversion. For stemming, “histories” can be converted to “history” and for case conversion “History” can be converted to “history”. For example, the sentence “Let's make discussions” can be parsed as “Let/VB's/POS make/VB [NP discussions/NNS]”, where VB denotes a verb, POS denotes a special part of speech, NP denotes a noun phrase and NNS denotes a plural noun. The noun phrase “discussions” can then be stemmed to “discussion”.

Next, applicable noun phrase patterns are selected for extraction at step 308 based on the identified parts of speech. For example, a phrase pattern of “noun”+“noun” (i.e. data service or SQL server) will be accepted but a pattern “verb”+“adverb” (i.e. work hard) will be rejected. At step 310, filtering criteria can be applied to the noun phrase patterns selected in step 308. For example, noun phrase patterns that are too short may be filtered. The amount of words in a noun phrase can be specified by a user. At step 312, the terms and/or phrases that are found are saved and counted.

At step 314, it is determined whether there are additional sentences within the row to be processed. If there are additional sentences, method 300 returns to step 304. If no additional sentences are found in the row, method 300 proceeds to step 316 where it is determined whether there are additional rows in the document. If additional rows are found, method 300 returns to step 302. If no additional rows are found, method 300 proceeds to step 318, wherein additional filtering can be applied. For example, terms from an exclusion term list can be filtered from a final output of the term extraction transformation. Additionally, tf-idf ranking can be used to apply filtering as discussed above. At step 320, the term list is loaded to an output database. As mentioned earlier, the output includes a glossary of terms that are indicative of a pattern in a collection of documents.

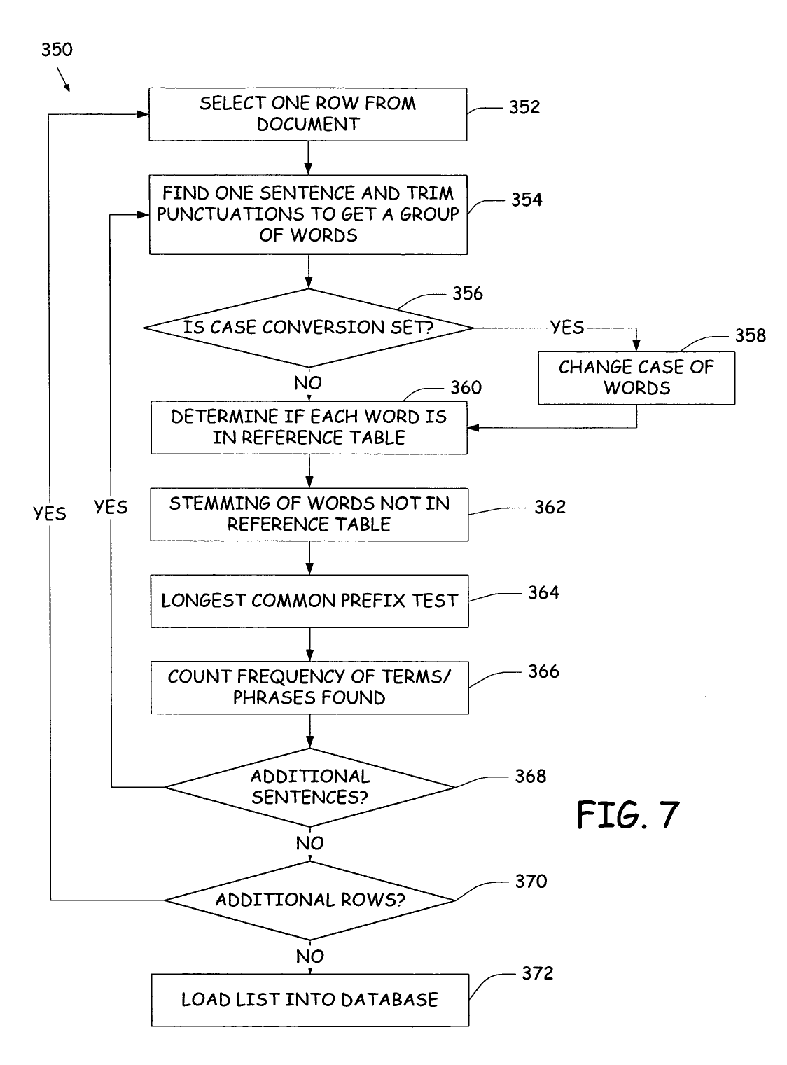

FIG. 7 is a flow diagram of a method 350 for performing a term look-up transformation on one or more documents. At step 352, one row is selected from the document. Next, one sentence is found and punctuations are trimmed in order to get a group of words at step 354. At step 356, it is determined whether case conversions is set for the term look-up transformation. This determination can be useful in identifying proper nouns. For example, “Windows” can denote an operating system if capitalized and thus a user may not want the case to be converted. If case conversion is set, method 350 proceeds to step 358 wherein the case for the group of words is changed. After the case is changed, the method 350 proceeds to step 360. If case conversion is not set, step 358 is skipped and method 350 proceeds directly to step 360.

At step 360, each word is analyzed to see if each word is in a reference look-up table. The reference look-up table, for example, can be a glossary as developed using a term extraction transformation discussed above with regard to FIG. 6 or another list of terms. For each word that is not found in the reference table, a stemming operation is performed at step 362. For example, if the word “servers” is not found in the reference table, the stemming operation performed at step 362 will stem “servers” to “server”.

After stemming or if the word is found in the reference table, a longest common prefix test is performed at step 364. The longest common prefix test combines the words determined in step 354 and matches the longest common prefix that is in the reference table. For example, if a given sentence includes “Windows XP Professional Edition is very powerful” and the reference table includes the terms “windows”, “Windows XP”, and “Windows XP Professional Edition” the longest common prefix test will only count “Windows XP Professional Edition”, and not “Windows” or “Windows XP”.

At step 366, the frequency of the terms and phrases found in the reference table is counted. This count is used to populate at least a portion of an output database. At step 368, it is determined whether additional sentences are found in the row. If there are additional sentences, method 350 returns to step 354. Otherwise, method 350 proceeds to step 370 where it is determined if there are additional rows in the document. If additional rows are found, method 350 returns to step 352 and otherwise loads a list of the terms in a database at step 372.

As mentioned above, the term extraction and term look-up transformations can be implemented in an extraction, transformation and loading environment such as data transformation services (DTS). DTS provides a set of graphical tools to centralize data for improved decision making. The DTS tools can create custom data movement solutions that are tailored towards a particular need.

A DTS package is an organized collection of connections, DTS tasks, DTS transformation and work flow constraints assembled with either a DTS tool or programmatically saved to a file. For example, the file can be a structured storage file. Each package contains one or more steps that are executed sequentially or in parallel when the package is executed. The package contains parameters to connect to data sources, copy data in database objects, transform data and notify other users or processes of events. Packages can be edited, password protected, scheduled for execution and retrieved.

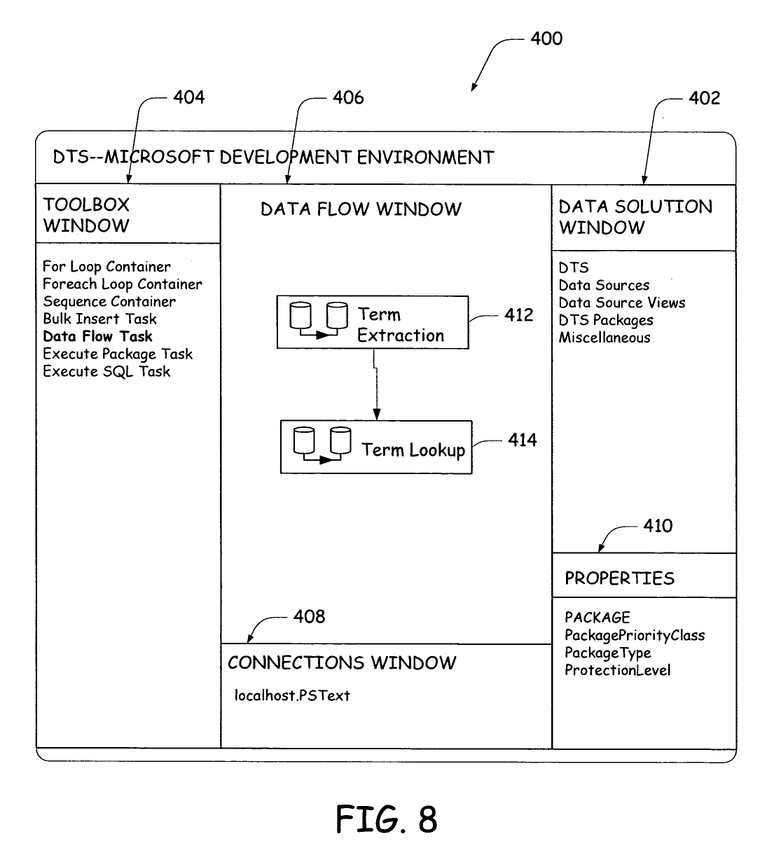

A DTS task is a descrete set of functionality that is executed as a single step in a package. Each task defines a work item to be performed as part of the data movement and data transformation process. Alternatively, the task can be executed at run-time. A DTS transformation includes one or more functions or operations applied to a piece of data before the data arrives at a destination. FIG. 8-10 below provide exemplary screen shots for establishing a data movement pipeline.

FIG. 8 is an exemplary screen shot of user interface 400 for providing a reference connection between a term extraction transformation and a term look-up transformation. The look-up transformation uses a table developed by the term extraction transformation to perform the look-up process. User interface 400 includes a data solution window 402 having options for selecting data transformation services, for example to define a data flow for a DTS package. A toolbox window 404 is also provided that includes several selectable options for defining the data flow. Data flow window 406 provides a graphical representation of data flow tasks that can be modified by a program developer. Connections window 408 lists connections to data sources and properties window 410 shows properties of items such as packages and transformations.

Data flow window 406 includes graphical representations of a term extraction transformation 412 and a term look-up transformation 414. An arrow connects the graphical representations 410 and 412 to create a visual representation of the data flow, which in this case is the look-up transformation referencing the term extraction transformation.

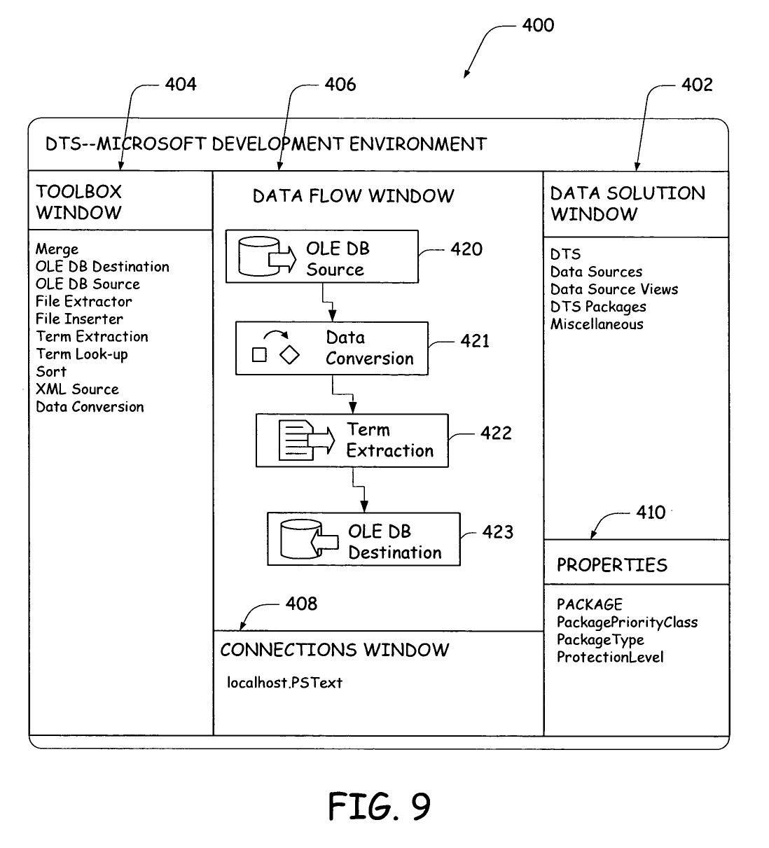

FIG. 9 illustrates a screen shot of user interface 400 that shows a data pipeline for the term extraction transformation. In data flow window 406, graphical representations 420-423 are shown of the data pipeline. Representation 420 illustrates a database source, which may have an associated connection in connection window 408. Data is extracted from data source 420 and a data conversion transformation 421 is then performed. The data conversion transformation 421 can be provided to convert data from source 420 into a more suitable form. The data pipeline also includes term extraction transformation 422, that is performed as discussed above. After the term extraction transformation 422 has been performed, data is loaded into a destination database 423.

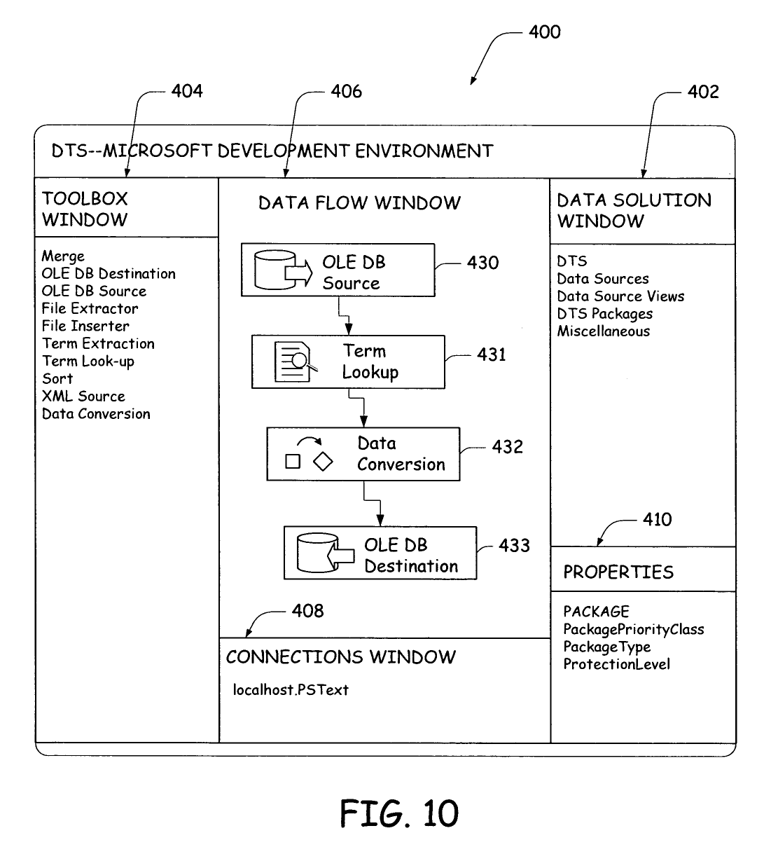

FIG. 10 illustrates a screen shot for user interface 400 for a term look-up data flow. Data flow window 406 includes graphical representation 430-433. In a term look-up transformation, data is extracted from a database source 430 and provided to term look-up transformation 431. Term look-up transformation 431 identifies terms within data source 430 as defined by the glossary provided by term extraction transformation 422 of FIG. 9. A data conversion transformation 432 can further be performed on the data provided by the term look-up transformation 431. Data resulting from the data conversion 432 is then provided to a destination database 433.

The graphical representations in the screen shots above can have various associated configurable parameters in order to customize the data flow. A connection can be defined for a database source as well as a database destination. A term extraction transformation 412 includes configurable parameters for establishing a connection to a database, inclusion terms and exclusion terms. The inclusion terms and the exclusion terms can be lists as described above. Furthermore, other options for term extraction relate to selecting whether terms can be words, phrases or words and phrases. Other parameters relate to frequency thresholds and a maximum length of terms allowed.

Other transformations, such as a term look-up transformation, can use other associated parameters to customize operation of a text mining process. In the term look-up transformation, a connection and a reference table can be specified in order to perform the look-up. Furthermore, source columns and destination columns can also be specified in the term look-up transformation.

By creating and defining a data flow pattern using term extraction and/or term look-up transformations, a reliable, efficient text mining process can be implemented. The process helps with identifying documents that are similar by establishing a glossary of common terms. Subsequent documents can further be classified by referencing the glossary.

Although the present invention has been described with reference to particular embodiments, workers skilled in the art will recognize that changes may be made in form and detail without departing from the spirit and scope of the invention.

1. A method for performing data mining, comprising:
selecting at least one data source of unstructured text;
selecting a transformation to identify a list of terms in the unstructured text; and
establishing a run-time path to connect the data source to the selected transformation to load the list of terms identified into a destination database.

2. The method of claim 1 and further comprising parsing the unstructured text to identify parts of speech.

3. The method of claim 2 wherein parsing further comprises using a statistical language model to identify parts of speech of words in the text.

4. The method of claim 1 and further comprising accessing a table of terms for identification in the unstructured text.

5. The method of claim 1 and further comprising performing further transformations on the identified list of terms.

6. The method of claim 1 and further comprising counting the number of times each term in the list of terms is encountered in the unstructured text.

7. The method of claim 1 and further comprising finding sentences within the unstructured text.

8. The method of claim 1 and further comprising removing terms from the list of terms that appear too frequently based on a threshold.

9. The method of claim 1 and further comprising removing terms from the list of terms that appear too infrequently based on a threshold.

10. The method of claim 1 and further comprising stemming words within the unstructured text and checking whether the stemmed word is in the list of terms.

11. The method of claim 1 and further comprising identifying noun phrases within the unstructured text.

12. The method of claim 1 and further comprising converting uppercase letters in the unstructured text to lowercase letters.

13. The method of claim 1 and further comprising selecting a second transformation and establishing the run-time path to include the second transformation.

14. The method of claim 1 and further comprising filtering the list of terms using a statistical measure based on the unstructured text.

15. The method of claim 1 and further comprising using a graphical user interface to establish the run-time path.

16. A computer readable medium including instructions that, when implemented, cause a computer to process information, the instructions comprising:
a data transformation module adapted to identify a list of terms in unstructured text of a data source; and
a connection module adapted to establish a run-time path to connect the data source to the transformation module and connect the transformation module to a destination data base.

17. The computer readable medium of claim 16 and wherein the instructions further comprise a parsing module adapted to identify parts of speech in the unstructured text.

18. The computer readable medium of claim 17 wherein the parsing module uses a statistical language module.

19. The computer readable medium of claim 16 wherein the transformation module is further adapted to access a table of terms for identification in the unstructured text.

20. The computer readable medium of claim 16 wherein the instructions further comprise a second transformation module adapted to perform a transformation on the identified list of terms.

21. The computer readable medium of claim 16 wherein the transformation module is further adapted to count the number of times each term in the list of terms is encountered in the unstructured text.

22. The computer readable medium of claim 16 wherein the transformation module is further adapted to find sentences within the unstructured text.

23. The computer readable medium of claim 16 wherein the transformation module is further adapted to remove terms from the list of terms that appear too frequently based on a threshold.

24. The computer readable medium of claim 16 wherein the transformation module is further adapted to remove terms from the list of terms that appear too infrequently based on a threshold.

25. The computer readable medium of claim 16 wherein the transformation module is further adapted to stem words within the unstructured text and check whether the stemmed word is in the list of terms.

26. The computer readable medium of claim 16 wherein the transformation module is further adapted to identify noun phrases within the unstructured text.

27. The computer readable medium of claim 16 wherein the transformation module is further adapted to convert uppercase letter in the unstructured text to lower case letters.

28. The computer readable medium of claim 16 and further comprising a second transformation module included in the run-time path.

29. The computer readable medium of claim 16 wherein the transformation module is further adapted to filter a list of terms using a statistical measure based on the unstructured text.

30. The computer readable medium of claim 16 wherein the instructions further comprise a graphical user interface adapted to establish the run-time path.
